(19) United States
(12) Patent Application Publication
(10) Pub. No.: US 2008/0217431 A1
(43) Pub. Date: Sep. 11, 2008

(54) Spraying device for a fixing composition

(76) Inventor: Francois Le Bourhis, Aubervilliers (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/071,622

(22) Filed: Feb. 25, 2008

Related U.S. Application Data
(60) Provisional application No. 60/907,403, filed on Mar. 30, 2007.

(30) Foreign Application Priority Data
Feb. 23, 2007 (FR) 0753479

(51) Int. Cl. B05B 1/08

(52) U.S. Cl. 239/102.2; 239/102.1

(57) ABSTRACT

The present disclosure relates to a spraying device for a cosmetic composition comprising a container having inner space comprising a liquid cosmetic composition and provided with a spraying mechanism comprising:
a perforated membrane, wherein the membrane perforations allow the container inner space to communicate with the external environment,
an actuator for vibrating the membrane, and
a mechanism for making the liquid cosmetic composition contained in the container contact an inner surface of the membrane,
wherein the liquid cosmetic composition, under the effect of the membrane vibrations, flows through the perforations until reaching an outer surface of the membrane where it emerges as droplets, and
wherein the liquid cosmetic composition comprises, in a cosmetically acceptable medium, at least one fixing polymer.

This application claims benefit of U.S. Provisional Application No. 60/907,403, filed Mar. 30, 2007, the contents of which are incorporated herein by reference. This application also claims benefit of priority under 35 U.S.C. § 119 to French Patent Application No. FR 07 53479, filed Feb. 23, 2007, the contents of which are also incorporated herein by reference.

The present disclosure relates to a spraying device, designed as a spray, comprising a cosmetic composition which in turn comprises at least one fixing polymer, for styling, reshaping and/or holding the hair.

Hair lacquers and sprays currently available in the marketplace are generally composed of a liquid phase comprising at least one fixing polymer and are propelled by an aerosol-generating, liquefied gas kept under reduced pressure. Such gases generally comprise volatile organic compounds (VOC).

New regulations are being more and more widely implemented to reduce the amount of volatile organic compounds (VOC) that are released in the atmosphere by aerosol-generating gases.

To try to achieve such a reduction, a non VOC propellant gas such as HFA 152a may be used to partly or fully act as a substitute for the traditionally used propellant gases. However, the use of this type of gas is not allowed in all countries.

Another solution for limiting the release of VOC, in the case of a traditional aerosol, is to introduce a greater amount of water into the cosmetic compositions.

However, the quality and the cosmetic efficiency for cosmetic compositions comprising large amounts of water are unsatisfactory compared to formulations of the previous art because the presence of water may increase the drying time, which does not contribute to a good fixing power level.

Yet another way to reduce the amount of VOC is not to use any gas propellant, e.g., by using a spraying device provided with a mechanical pump. Each time the device is actuated, a unit dose of the product is delivered onto the hair. Such delivery discontinuity, however, may result in an uneven distribution of the product over the hair, and thus to a poor hair holding.

Surprisingly, the present inventor has discovered that using a specific spraying device, comprising a container and spray nozzle with a perforated membrane, actuated by a vibrating system, for example a piezoelectric system, and through which the liquid cosmetic composition is converted into droplets, when used in conjunction with a cosmetic composition comprising at least one fixing polymer makes it possible, without using VOC-generating propellant gases, to obtain an excellent hair fixing, as compared to the solutions of the previous art.

In at least one embodiment, therefore, the present disclosure relates to a device for spraying a liquid cosmetic composition comprising a container provided with a spraying mechanism comprising:

a perforated membrane, wherein the perforations of the membrane allow the inner space of the container to communicate with the external environment,

an actuator for vibrating the membrane, and

a mechanism for making a liquid cosmetic composition contained in the container contact an inner surface of the membrane,

wherein the liquid cosmetic composition, under the effect of the membrane vibrations, flows through the perforations until reaching an outer surface of the membrane from which it emerges as droplets, and
wherein the liquid cosmetic composition comprises, in a cosmetically acceptable medium, at least one fixing polymer.

The perforations in the membrane, in at least one embodiment, have a reverse taper, i.e., a cross-sectional area that is larger on the outer surface of the membrane facing the external environment, than on the inner surface, facing the interior of the container.

Moreover, the spraying device may comprise a pressure bias means, such as described in International Patent Application No. WO 95/15822, providing a reduced pressure to the liquid contacting the inner surface of the membrane. The reduced pressure may vary from ambient pressure to the pressure at which the air is sucked-in through the perforations of the membrane contacting the composition.

In at least one embodiment of the present disclosure, the perforations on the outer surface of the membrane do not contact each other.

In at least one embodiment, the actuator is a piezoelectric actuator, conceived, for example for making the membrane vibrate in a frequency range ranging from 20 KHz to 7 MHz. The energy necessary for the actuator piezoelectric to run may be obtained from an electric generator, for example an electric cell, a battery or a photovoltaic cell that may be optionally coupled with an electronic circuit.

In the hereabove defined spraying device, the mechanism for conveying the liquid cosmetic composition to the surface of the membrane may comprise a capillary-based feeding mechanism, or alternatively, a bubble generator-based feeding mechanism. Such mechanisms are described, for example in International Patent Application No. WO 95/15822.

According to at least one embodiment of the present disclosure, all the perforations have a reverse taper. In another embodiment, the membrane is additionally provided with normally tapered perforations.

As used herein, “normally tapered perforation” is understood to mean a perforation with a smaller cross-sectional area on the outer surface of the membrane facing the external environment, than on the inner surface, facing the interior of the container.

When normally tapered perforations are present, these perforations are, for example, arranged all around and on the outside of the reverse tapered perforations.

The mechanism for conveying the liquid cosmetic composition to the surface of the membrane may be designed so as to convey said composition to the inner surface of said membrane, or on the contrary, be designed so as to convey said composition to the outer surface of said membrane. Such alternative versions of the spraying device are described, for example, in International Patent Application No. WO 95/15822.

By way of non-limiting example, the membrane may be designed as a circular plate of 8 mm diameter, in electroformed nickel, with a 70 μm thickness and having a plurality of perforations. The perforations may have a cross-sectional area in the form of a circular plate which has a diameter ranging from 4 to 150 μm on the outer surface of the membrane facing the external environment, and on the inner surface facing the inside of the container, a cross-sectional area in the form of a circular plate with a diameter ranging from 2 to 50 μm, for example ranging from 10 to 20 μm.

When using the device, the cosmetic composition is dispensed as droplets with a mean diameter ranging from 20 to 100 μm, for example ranging from 30 to 60 μm.

As used herein, “fixing polymer” is understood to mean any polymer that may provide the hair with a shape and/or that may be able to retain this shape.

According to the present disclosure, any fixing polymer known in the field of hair care may be used, for example cationic, anionic, amphoteric and/or non ionic fixing polymers as well as mixtures comprising several of such polymers.

Suitable cationic fixing polymers according to the present disclosure include, but are not limited to polymers having primary, secondary, tertiary and/or quaternary amine groups making part of the polymer chain or directly bound to it, and having a molecular weight ranging from 500 to about 5 000 000, for instance from 1000 to 3 000 000.

Non-limiting examples of these cationic polymers include:

(1) homopolymers or copolymers derived from acrylic or methacrylic esters or amides and having at least one of the following units:

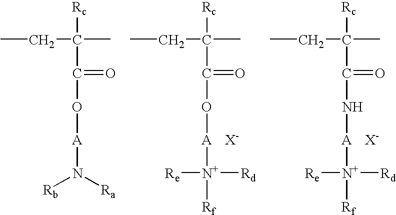

wherein:
Rₐ and R_{b} are each independently chosen from a hydrogen atom and a C₁-C₆ alkyl group,
R_{c} is chosen from a hydrogen atom and a CH₃ radical,
R_{d}, Rₑ and R_{f}, are each independently chosen from a C₁₋₁₈ alkyl group and a benzyl radical,
A is chosen from a linear or branched C₁₋₆ alkyl group and a C₁₋₄ hydroxyalkyl group, and
X⁻ is a methosulfate or halide anion, such as a chloride or bromide ion.

Copolymers of family (1) comprise, moreover, one or more unit(s) derived from comonomers that may be chosen from the family including acrylamides, methacrylamides, diacetone-acrylamides, acrylamides and methacrylamides substituted on the nitrogen atom with lower alkyl groups, acrylic or methacrylic acids or esters thereof, vinyl lactames such as vinyl pyrrolidone or vinyl caprolactame, and vinyl esters.

Thus, non-limiting mention may be made of the following copolymers of family (1):
copolymers of acrylamide and dimethylaminoethyl methacrylate quaternized with dimethyl sulfate or with a dimethyl halide, such as the one marketed under the trade name HERCOFLOC® by the HERCULES company;
copolymers of acrylamide and methacryloyl-oxyethyl trimethylammonium chloride described for example in European Patent Application No. EP-A-080 976 and marketed, for instance, under the trade name BINA QUAT® P 100 by the CIBA GEIGY company;
the copolymer of acrylamide and methacryloyloxyethyl trimethylammonium methosulfate marketed, for example, under the trade name RETEN® by the HERCULES company;
copolymers of vinyl pyrrolidone and dialkylaminoalkyl acrylate or methacrylate quaternized or not, such as the products marketed under the trade name GAFQUAT® by the ISP company, as for example GAFQUAT® 734 or GAFQUAT® 755, or the COPOLYMER® 845, 958 and 937 products. These polymers are described in detail in French Patent Application Nos. FR 2.077.143 and FR 2.393.573;
terpolymers of dimethylaminoethyl methacrylate, vinyl caprolactame and vinyl pyrrolidone, such as the product marketed under the trade name GAFFIX VC 713 by the ISP company; and
the copolymer of vinyl pyrrolidone and quaterinzed dimethylaminopropyl methacrylamide, such as the product marketed under the trade name GAFQUAT® HS 100 by the ISP company.

(2) the quaternized polysaccharides described, for example in U.S. Pat. No. 3,589,578 and U.S. Pat. No. 4,031,307 such as guar gums comprising trialkylammonium cationic groups.

Such products are marketed, for instance under the trade names JAGUARS C13 S, JAGUAR® C15 and JAGUAR® C17 by the MEYHALL company.

(3) Quaternary copolymers of vinyl pyrrolidone and vinyl imidazole such as the products marketed by BASF under the trade name LUVIQUAT® TFC,

(4) chitosans or their salts, for example chitosan acetate, lactate, glutamate, gluconate and pyrrolidone carboxylate.

According to at least one embodiment, chitosan with a desacetylation rate of 90.5% by weight marketed under the trade name KYTAN BRUT STANDARD® by the ABER TECHNOLOGIES company, and chitosan pyrrolidone carboxylate marketed under the trade name KYTAMER® PC by the AMERCHOL company may be used.

(5) Cellulose cationic derivatives such as cellulose copolymers and cellulose derivatives graft with a water-soluble monomer comprising a quaternary ammonium group, for example those described in U.S. Pat. No. 4,131,576 such as hydroxyalkyl celluloses, and hydroxymethylhydroxyethyl- or hydroxypropyl celluloses graft with a methacryloyloxyethyl trimethylammonium salt, a methacrylamidopropyl trimethylammonium salt or a dimethyl diallylammonium salt.

The marketed products corresponding to such a definition include, but are not limited to the products sold, for example under the trade names CELQUAT® L 200 and CELQUAT® H 100 by the NATIONAL STARCH company.

Useful anionic fixing polymers according to the present disclosure include, but are not limited to polymers comprising groups derived from a carboxylic, a sulfonic or a phosphoric acid and have a weight average molecular weight ranging from about 500 to 5 000 000.

The carboxylic acid groups useful herein are carried by unsaturated monomers comprising one or two carboxylic acid function(s), such as those of the following formula:

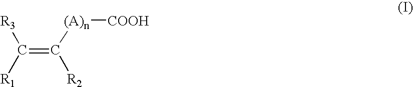

wherein
n is an integer ranging from 0 to 10;
A is a methylene group, optionally bound to the carbon atom of the unsaturated group or of the adjacent methylene group, when n is higher than 1, through a heteroatom such as oxygen or sulfur,
R₃ is chosen from a hydrogen atom, a phenyl and a benzyl group,
R₁ is chosen from a hydrogen atom, a lower alkyl and a carboxyl group, and
R₂ is chosen from a hydrogen atom, a lower alkyl group, a —CH₂—COOH, a phenyland a benzyl group.

According to at least one embodiment of the present disclosure, a lower alkyl radical, as defined above, is for example a C₁-C₄ alkyl group such as a methyl or an ethyl group.

Suitable examples of carboxylated anionic fixing polymers according to the present disclosure include, but are not limited to:

A) homo- or copolymers of acrylic or methacrylic acid or their salts, such as the products marketed under the trade names VERSICOL® E or K by the ALLIED COLLOID company, and under the trade name ULTRAHOLD® by the BASF company; copolymers of acrylic acid and acrylamide marketed in the form of sodium salt under the trade names RETEN® 421, 423 or 425 by the HERCULES company; the sodium salts of polyhydroxycarboxylic acids.

B) Copolymers of acrylic acid or methacrylic acid and of a monoethylene-based monomer such as ethylene, styrene, vinyl esters, acrylic and methacrylic acid esters.

These copolymers may be graft on a polyalkylene glycol such as polyethylene glycol and are optionally crosslinked.

Such polymers are described, for example in French Patent Application No. FR 1 222 944 and German Patent Application No. DE 2 330 956. Non-limiting mention may also be made of copolymers comprising in their chain an optionally N-alkylated and/or hydroxyalkylated acrylamide unit, such as those described in Luxembourg Patent Application Nos. LU 75370 and LU75371 or those under the trade name QUADRAMER® by the AMERICAN CYANAMID company.

Other useful copolymers include, but are not limited to copolymers of acrylic acid and C₁-C₄ alkyl methacrylate, and terpolymers of vinyl pyrrolidone, (meth)acrylic acid and C₁-C₂₀ alkyl (meth)acrylate, for example lauryl (ACRYLDONE® LM from the ISP company), of tertbutyl (LUVIFLEX® VBM 70 marketed by BASF) or of methyl (STEPANHOLD® EXTRA marketed by STEPAN), and terpolymers of methacrylic acid, ethyl acrylate and tertbutyl acrylate such as the product marketed under the trade name LUVIMER® 100 P by the BASF company.

C) Copolymers derived from crotonic acid, such as those comprising in their chain vinyl acetate or propionate units and optionally other monomers such as allyl, methallyl or vinyl esters of a linear or branched, hydrocarbon long-chain, saturated carboxylic acid comprising at least 5 carbon atoms, where these polymers may be optionally graft and crosslinked, or vinyl, allyl or methallyl esters of a carboxylic α- or β-cyclic acid.

Such polymers are described for instance, in French Patent Application Nos. FR 1 222 944, FR 1 580 545, FR 2 265 782, FR 2 265 781, FR 1 564 110 and FR 2 439 798.

Suitable examples of commercial polymer products belonging to this class, include but are not limited to the 28-29-30, 26-13-14 and 28-13-10 resins, which are marketed by the NATIONAL STARCH company and MEXOMERE PW available from the CHIMEX company.

D) Copolymers derived from monounsaturated C₄-C₈ carboxylic acids or anhydrides chosen from:
copolymers comprising:
(ii) one or more maleic, fumaric, itaconic acid(s) or anhydride(s) and
(iii) at least one monomer chosen from vinyl esters, vinyl ethers, vinyl halides, phenylvinyl derivatives, acrylic acid and esters thereof, wherein the anhydride functions of these copolymers are optionally monoesterified or monoamidified.

Such polymers are described for example in U.S. Pat. No. 2,047,398, U.S. Pat. No. 2,723,248, U.S. Pat. No. 2,102,113 and Great Britain Patent No. GB 839,805 and those marketed under the trade names GANTREZ AN or ES, AVANTAGE® CP by the ISP company;
copolymers comprising (i) one or more maleic, citraconic or itaconic anhydride(s) and (ii) one or more monomer(s) chosen from allyl or methallyl esters optionally comprising in their chain one or more acrylamide, methacrylamide, α-olefin, acryl or methacryl esters, acrylic or methacrylic acids or vinyl pyrrolidone groups, wherein the anhydride functions of these copolymers are optionally monoesterified or monoamidified.

These polymers are described, for example in French Patent Application Nos. FR 2 350 384 and FR 2 357 241.

E) Polyacrylamides comprising carboxylate groups.

F) Branched acrylic block copolymers, for example branched block copolymers comprising as main monomers at least one C₁-C₂₀ alkyl acrylate and/or at least one N mono- or N,N di-(C₂-C₁₂ alkyl)(meth)acrylamide and acrylic acid and/or methacrylic acid. These fixing polymers are branched block copolymers with a structure comprising hydrophobic blocks to which they are bound, for instance, through bifunctional units, with a certain amount of more hydrophilic blocks. These copolymers have at least two glass transition temperatures.

Such copolymers are described, for example in International Patent Application No. WO 00/40628.

Non-limiting mention may be made of the branched block copolymers described above for example under the trade names EX-SDR-26® and EX-SDR-45® from the GOODRICH company, and EX-SDR-752 (FIXATE G100L from NOVEON).

These copolymers typically have the following composition:

Acrylic acid from 26 to 36 mole percent;

N-butyl-acrylate from 27.5 to 30.5 mole percent;

Methacrylic acid from 33.3 to 45.3 mole percent; and

Allyl methacrylate from 0.48 to 0.92 mole percent.

As disclosed herein, the most hydrophobic blocks have a molecular weight ranging from 10 000 to 100 000 and the most hydrophilic blocks have a molecular weight ranging from 1000 to 100 000 Daltons.

The anionic groups of the anionic fixing polymers according to the present disclosure may also be sulfonic acid groups carried by vinyl sulfonic, styrene sulfonic, naphthalene sulfonic or acrylamidoalkyl sulfonic units.

According to at least one embodiment, these sulfonic acid group-containing polymers are chosen from:
poly(vinyl sulfonic acid) salts having a weight average molecular weight ranging from about 1000 to 100 000 as well as copolymers of vinyl sulfonic acid and an unsaturated comonomer such as acrylic acid, methacrylic acid, esters of these acids, acrylamide, acrylamide derivatives, vinyl ethers and vinyl pyrrolidone;
poly(styrene sulfonic acid) salts. Suitable examples thereof include two sodium salts having a weight average molecular weight of about 500 000 and of about 100 000, marketed for example under the trade names FLEXAN® 500 and FLEXAN® 130 by the NATIONAL STARCH company. These compounds are described, for instance in French Patent No. FR 2 198 719;
poly(acrylamide sulfonic acid) salts, such as those mentioned in U.S. Pat. No. 4,128,631 and poly(acrylamidoethyl propanesulfonic acid) salt marketed, for example, under the trade name COSMEDIA POLYMER® HSP 1180 by the HENKEL company; and
linear sulfonic polyesters.

As used herein, “sulfonic polyester” is understood to mean copolyesters obtained by polycondensing at least one dicarboxylic acid or an ester thereof, at least one diol and at least one sulfoaryl dicarboxylic bifunctional compound substituted on the aromatic ring with a —SO3M group, wherein M is chosen from a hydrogen atom and a metal ion such as Na+, Li+ or K⁺.

Water-dispersible linear sulfonic polyesters typically have a weight average molecular weight ranging from about 1 000 to 60 000, for instance ranging from 4 000 to 20 000, as determined by gel-permeation chromatography (GPC).

The glass transition temperature (Tg) for these sulfonic polyesters typically ranges from 10° C. to 100° C. In at least one embodiment, the Tg for the polyester is higher than or equal to 50° C.

As disclosed herein, the glass transition temperature (Tg) is measured by a differential scanning calorimetry (DSC) according to the ASTM D3418-97 standard.

The water-dispersible linear sulfonic polyesters are described for instance in U.S. Pat. No. 3,734,874, U.S. Pat. No. 3,779,993, U.S. Pat. No. 4,119,680, U.S. Pat. No. 4,300,580, U.S. Pat. No. 4,973,656, U.S. Pat. No. 5,660,816, U.S. Pat. No. 5,662,893, and U.S. Pat. No. 5,674,479.

Other useful sulfonic polyesters according to the present disclosure include sulfonic polyesters derived from isophthalic acid, sulfoaryl dicarboxylic acid and diethylene glycol salt, for example, the sulfonic polyesters derived from isophthalic acid, sulfoisophthalic acid, sodium salt, diethylene glycol and 1,4-cyclohexanemethanol.

Suitable examples of sulfonic polyesters include, but are not limited to those known under the INCI name Diglycol/CHDM/Isophtalates/SIP, and sold, for instance under the trade names “Eastman AQ polymer” (AQ35S, AQ38S, AQ55S, AQ48 Ultra) by the Eastman Chemical company.

According to at least one embodiment of the present disclosure, the Tg for the polyester is higher than or equal to 50° C.

Non-limiting examples of anionic polymers that are used according to the present disclosure include acrylic acid-based copolymers, such as the terpolymer of acrylic acid, ethyl acrylate and N-tertbutyl acrylamide marketed under the trade name ULTRAHOLD STRONG® by the BASF company, copolymers derived from crotonic acid such as terpolymers of vinyl acetate, vinyl p-tert-butylbenzoate and crotonic acid (MEXOMERE PW from the CHIMEX company) and terpolymers of crotonic acid, vinyl acetate and vinyl neododecanoate marketed under the trade name Resin 28-29-30 by the NATIONAL STARCH company, polymers derived from maleic, fumaric, itaconic acids or anhydrides with vinyl esters, vinyl ethers, vinyl halides, phenylvinyl derivatives, acrylic acid and esters thereof such as the copolymer of methylvinyl ether and monoesterified maleic anhydride marketed under the trade name GANTREZ® ES 425 by the ISP company, the copolymer of methacrylic acid and ethyl acrylate marketed under the trade name LUVIMER® MAEX by the BASF company, the terpolymer of vinyl pyrrolidone, acrylic acid, laurylalkyl methacrylate sold by the ISP company under the trade name ACRYLIDONE LM and the copolymer of vinyl acetate and crotonic acid marketed under the trade name LUVISET® CA 66 by the BASF company and the terpolymer of vinyl acetate, crotonic acid and polyethylene glycol marketed under the trade name ARISTOFLEX® A by the BASF company, the linear sulfonic polyesters, such as AQ55S from the EASTMAN company, branched acrylic block copolymers and FIXATE G100L from the NOVEON company.

Useful amphoteric fixing polymers according to the present disclosure include, but are not limited to polymers comprising B and C units randomly distributed within the polymer chain, wherein B is a unit derived from a monomer comprising at least one basic nitrogen atom and C is a unit derived from a monomer comprising one or more carboxylic acid or sulfonic acid group(s). Such amphoteric fixing polymers may also comprise zwitterionic units of the carboxybetaine or sulfobetaine type. They also may be polymers with a cationic main chain comprising primary, secondary, tertiary or quaternary amine groups, amongst which at least one, carries, through a hydrocarbon radical, a carboxylic acid or sulfonic acid group. Amphoteric fixing polymers may further have an anionic-type chain derived from unsaturated α,β-dicarboxylic acids, wherein one carbonyl group of which has been reacted with a polyamine comprising one or more primary or secondary amine group(s).

Examples of amphoteric fixing polymers as defined above include, but are not limited to the following polymers:
(1) polymers resulting from the copolymerization of a vinyl monomer carrying a carboxylic acid group such as acrylic acid, methacrylic acid, maleic acid, α-chloroacrylic acid and of a vinyl monomer comprising at least one basic function such as dialkylaminoalkyl methacrylate and acrylate or dialkylaminoalkyl (meth)acrylamides. Such compounds are described, for example in U.S. Pat. No. 3,836,537.
(2) Polymers comprising units derived from:
   (a) at least one monomer chosen from N-alkylated acrylamides and methacrylamides,
   (b) at least one comonomer comprising one or more carboxylic acid function(s), and
   (c) at least one basic comonomer such as acrylic acid and methacrylic acid esters with primary, secondary, tertiary or quaternary amine substituents and the quaternization product from dimethylaminoethyl methacrylate with dimethyl or diethyl sulfate.

Useful N-alkylated acrylamides or methacrylamides (a) according to the present disclosure, are those carrying C₂₋₁₂ alkyl radicals, such as N-ethyl acrylamide, N-tertbutyl acrylamide, N-tert-octyl acrylamide, N-octyl acrylamide, N-decyl acrylamide, N-dodecyl acrylamide as well as corresponding methacrylamides.

Carboxylic acid group-containing comonomers (b) useful herein include, but are not limited to acrylic, methacrylic, crotonic, itaconic, maleic and fumaric acids, as well as maleic or fumaric acid or anhydride C₁₋₄ alkyl monoesters.

Non-limiting examples of basic comonomers (c) are aminoethyl methacrylate, butylaminoethyl methacrylate, N,N′-dimethylaminoethyl methacrylate and N-tertbutylaminoethyl methacrylate.

Other useful copolymers according to the present disclosure include, but are not limited to copolymers with a CTFA name (4th Ed., 1991) corresponding to “Octyl acrylamide/acrylates/butylaminoethylmethacrylate copolymer,” such as the products marketed under the trade name AMPHOMER® or LOVOCRYL® 47 by the NATIONAL STARCH company.

(3) Crosslinked and alkylated polyaminoamides, derived partially or fully from polyaminoamides having the following formula:

—[C(═O)—R₄—C(═O)-Z-]- (II)

wherein
R₄ is a divalent radical derived from a saturated dicarboxylic acid, an ethylene double bond mono- or dicarboxylic aliphatic acid, a C₁₋₆ alkyl ester of these acids or a radical resulting from adding any amongst said acids to a bis-primary or bis-secondary amine, and
Z is chosen from a bis-primary, mono- and bis-secondary polyalkylene polyamine radical, for example:

a) in amounts ranging from 60 to 100 mole percent, the radical:

—NH—[(CH₂)ₓ—NH]ₚ— (III)

wherein x=1 and p=2 or 3, or x=3 and p=2,
said radical being derived from diethylene triamine, triethylene tetraamine or dipropylene triamine;

b) in amounts ranging from 0 to 40 mole percent, the radical of formula (III) wherein x=2 and p=1, derived from ethylene diamine, or the radical

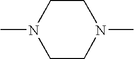

derived from piperazine:

c) in amounts ranging from 0 to 20 mole percent, the —NH—(CH₂)₆—NH— radical derived from hexamethylene diamine, these polyaminoamines being crosslinked by adding from 0.025 to 0.35 mole per amine group mole, of a bifunctional crosslinking agent chosen from epihalohydrines, diepoxides, dianhydrides, di-unsaturated compounds which are alkylated with acrylic acid, chloroacetic acid or an alkane-sulfone.

Saturated carboxylic acids useful herein include, but are not limited to acids comprising from 6 to 10 carbon atoms such as adipic acid, trimethyl-2,2-4-adipic acid and trimethyl-2,4,4-adipic acid, terephthalic acid, ethylene double bond acids, for example acrylic, methacrylic and itaconic acids.

Alkane-sulfones used in the alkylation are for example propanesulfone or butanesulfone.

Useful alkylating agent salts are for instance the sodium or potassium salts.

(4) Polymers comprising zwitterionic units of formula:

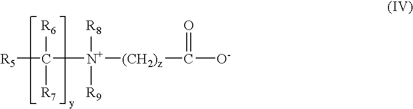

wherein
R₅ is an unsaturated polymerizable group such as an acrylate, methacrylate, acrylamide or methacrylamide group,
y and z are each an integer ranging from 1 to 3,
R₆ and R₇ are each independently chosen from a hydrogen atom and a methyl, ethyl or propyl group,
R₈ and R₉ are each independently chosen from a hydrogen atom and an alkyl radical,
wherein the total number of carbon atoms in R₈ and R₉ does not exceed 10.

Polymers which do comprise such units of formula (IV) may further comprise units derived from non zwitterionic monomers such as dimethyl or diethylaminoethyl acrylate or methacrylate, alkyl acrylates or methacrylates, vinyl acrylamides or methacrylamides or acetate.

By way of non-limiting example, the copolymer of methyl methacrylate and dimethylcarboxymethyl ammonioethyl methacrylate may be mentioned, such as the product marketed under the trade name DIAFORMER® Z301 by the SANDOZ company.

(5) Polymers derived from chitosan comprising monomer units having the following formulae:

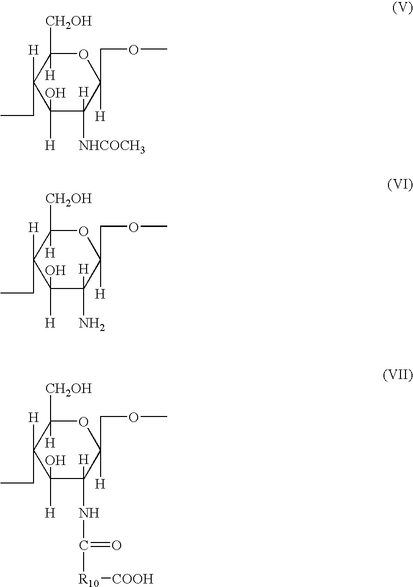

wherein the unit of formula (V) is present in an amount ranging from 0 to 30%, the unit of formula (VI) in an amount ranging from 5 to 50% and the unit of formula (VII) in an amount ranging from 30 to 90%, wherein R₁₀ in formula VII defined above is a radical of formula:

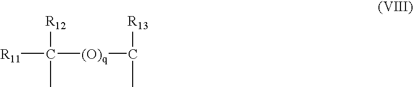

wherein:

if q=0, then R₁₁, R₁₂ and R₁₃, are each independently chosen from a hydrogen atom, a methyl, hydroxyl, acetoxy and amino group, a monoalkyl amine and dialkyl amine group optionally interrupted by one or more nitrogen atom(s) and/or optionally substituted with one or more amine, hydroxyl, carboxyl, alkylthio or sulfo group(s), an alkylthio group, the alkyl group of which carries an amino residue, wherein at least one of the radicals R₁₁, R₁₂ and R₁₃ in that case is a hydrogen atom; or if q=1, then R₁₁, R₁₂ and R₁₃ are each hydrogen atoms, as well as salts formed by these compounds with bases or acids.

6) Polymers obtained by N-carboxyalkylation of chitosan, such as N-carboxymethylchitosan or N-carboxybutylchitosan marketed under the trade name EVALSAN® by the JAN DEKKER company.

(7) Polymers having the formula (IX):

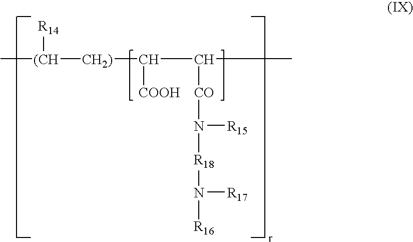

described, for example, in French Patent Application No. FR 1 400 366, wherein
r is an integer greater than or equal to 1,
R₁₄ is chosen from a hydrogen atom and a CH₃O, CH₃CH₂O or phenyl radical,
R₁₅ is chosen from a hydrogen atom and a lower alkyl radical such as a methyl or ethyl radical,
R₁₆ is chosen from a hydrogen atom and a lower alkyl radical such as a methyl or ethyl radical, and
R₁₇ is chosen from a lower alkyl radical such as a methyl or ethyl radical and a radical having following formula:

—R₁₈—N(R₁₆)₂,

wherein R₁₈ is a —CH₂—CH₂—, —CH₂—CH₂—CH₂—, —CH₂—CH(CH₃)— group, and R₁₆ is as previously defined, as well as higher homologues of these radicals comprising up to 6 carbon atoms.

(8) Amphoteric polymers of the -D-X-D-X- type chosen from:
(a) polymers obtained by reacting chloroacetic acid or sodium chloroacetate with compounds comprising at least one unit of formula:

-D-X-D-X-D- (X)

wherein D is a radical:

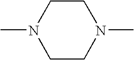

and X is the E or E′ symbol, wherein E or E′ are identical or different and are chosen from bivalent radicals which are straight- or branched-chain alkylene radicals comprising up to 7 carbon atoms in the main chain and are optionally substituted with hydroxyl groups and which may further comprise oxygen, nitrogen or sulfur atoms, and may comprise from 1 to 3 aromatic and/or heterocyclic ring(s), oxygen, nitrogen or sulfur atoms being present as ether, thioether, sulfoxide, sulfone, sulfonium, alkyl amine, alkenyl amine groups, hydroxyl, benzyl amine, amine oxide, quaternary ammonium, amide, imide, alcohol, ester and/or urethane groups.

b) Polymers of formula:

-D-X′-D-X′- (X′)

wherein D is a radical

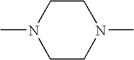

and X′ is the E or E′ symbol and at least one time E′, wherein E is as defined above and E′ is a divalent radical which is a straight- or branched-chain alkylene radical having up to 7 carbon atoms in the main chain, optionally substituted by one or more hydroxyl radical(s) and comprising one or more nitrogen atom(s), said nitrogen atom being substituted by an alkyl chain optionally interrupted by an oxygen atom and comprising one or more carboxyl function(s) or one or more hydroxyl function(s) and betainized by reacting with chloroacetic acid or sodium chloroacetate.

9) Copolymers of (C₁₋₅)alkyl vinyl ether and maleic anhydride partly modified by half-amidification with a N,N-dialkylaminoalkyl amine such as N,N-dimethylaminopropyl amine, or half-esterification with a N,N-dialkanol amine. These copolymers may also comprise other vinyl comonomers such as vinyl caprolactame.

Non-limiting examples of amphoteric fixing polymers according to the present disclosure are those of family (3) as described above, such as those with a CTFA name corresponding to “Octylacrylamide/acrylates/butylaminoethyl-methacrylate copolymer” or the products marketed, for example under the trade names AMPHOMER®, AMPHOMER® LV 71 or LOVOCRYL® 47 by the NATIONAL STARCH company.

Other useful amphoteric fixing polymers are those of family (4), for example copolymers of methyl methacrylate and dimethylcarboxymethyl ammonioethyl methacrylate, marketed for instance under the trade name DIAFORMER® Z301 by the SANDOZ company.

The anionic or amphoteric fixing polymers may, in at least one embodiment, be partly or fully neutralized. Examples of neutralizing agents include but are not limited to soda, potash, amino-2-methyl propanol, monoethanolamine, triethanolamine or tri-isopropanolamine, and mineral or organic acids such as hydrochloric acid or citric acid.

Suitable non ionic fixing polymers according to the present disclosure are chosen, for example from:
vinyl pyrrolidone homopolymers;
copolymers of vinyl pyrrolidone and vinyl acetate;
polyalkyl oxazolines such as polyethyl oxazolines available from the DOW CHEMICAL company under the trade names PEOX® 50 000, PEOX® 200 000 and PEOX® 500 000;
vinyl acetate homopolymers such as the product available under the trade name APPRETAN® EM by the HOECHST company or the product available under the trade name RHODOPAS® A 012 by the RHONE POULENC company;
copolymers of vinyl acetate and acrylesters such as the product available under the trade name RHODOPAS® AD 310 from RHONE POULENC;
copolymers of vinyl acetate and ethylene such as the product available under the trade name APPRETAN® TV from the HOECHST company;
copolymers of vinyl acetate and maleic ester, for example of dibutyl maleate such as the product available under the trade name APPRETAN® MB EXTRA from the HOECHST company;
copolymers of ethylene and maleic anhydride;
alkyl acrylate homopolymers and alkyl methacrylate homopolymers such as the product available under the trade name MICROPEARL® RQ 750 from the company MATSUMOTO or the product available under the trade name LUHYDRAN® A 848 S from the BASF company;
copolymers of acrylic esters, such as copolymers of alkyl acrylates and alkyl methacrylates, for example the products available from the ROHM & HAAS company under the trade names PRIMAL AC-261 K and EUDRAGIT NE 30 D, from the BASF company under the trade names ACRONAL® 601, LUHYDRAN® LR 8833 or 8845, and from the HOECHST company under the trade names APPRETAN® N 9213 or N 9212;
copolymers of acrylonitrile and a non ionic monomer chosen for example from butadiene and alkyl (meth)acrylates, for instance the products available under the trade names NIPOL® LX 531 B from the NIPPON ZEON company or those available under the trade name CJ 0610 B from the ROHM & HAAS company;
polyurethanes such as the products available under the trade names ACRYSOL® RM 1020 or ACRYSOL® RM 2020 from the ROHM & HAAS company, the products URAFLEX® XP 401 UZ, URAFLEX® XP and 402 UZ from the DSM RESINS company;
copolymers of alkyl acrylate and urethane such as the product 8538-33 marketed by the NATIONAL STARCH company;
polyamides such as the product ESTAPOR® LO 11 available from the RHONE POULENC company; and
chemically modified, or not, non ionic guar gums.

Non modified, non ionic guar gums useful herein may include, for example, the products marketed under the trade name VIDOGUM® GH 175 by the UNIPECTINE company and under the trade name JAGUAR® C by the MEYHALL company. Suitable modified non ionic guar gums according to the present disclosure have been modified with C₁₋₈ hydroxyalkyl groups. Non-limiting examples include hydroxymethyl, hydroxyethyl, hydroxypropyl and hydroxybutyl groups.

These guar gums are well known in the art and may be, for example prepared by reacting corresponding alkene oxides, such as propylene oxides with the guar gum so as to obtain a guar gum that has been modified with hydroxypropyl groups.

Such non ionic guar gums, that have been optionally modified with hydroxyalkyl groups are sold, for example, under the trade names JAGUAR® HP8, JAGUAR® HP60 and JAGUAR® HP120, JAGUAR® DC 293 and JAGUAR® HP 105 by the MEYHALL company, or under the trade name GALACTASOL® 4H₄FD2 by the AQUALON company.

According to at least one embodiment of the present disclosure, fixing polymers that may be used are also film-forming polymers of the graft silicone type, comprising one polysiloxane part and one part made of a non silicone organic chain, one of the two parts forming the polymer main chain and the other being grafted onto said main chain.

These polymers fare described, for example in European Patent Application Nos. EP-A-0 412 704, EP-A-0 412 707, EP-A-0582 152 and EP-A-0 640 105 and International Patent Application Nos. WO 95/00578 and WO 93/23009 and U.S. Pat. No. 4,693,935, U.S. Pat. No. 4,728,571 and U.S. Pat. No. 4,972,037.

These polymers are, for example anionic or non ionic.

Such polymers are, for example copolymers that might be obtained by a free-radical polymerization from a mixture of monomers comprising,

a) from 50 to 90% by weight of tertbutyl acrylate,

b) from 0 to 40% by weight of acrylic acid, and

c) from 5 to 40% by weight of a silicone-based macromer of following formula:

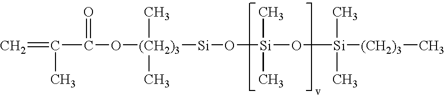

wherein v is a number ranging from 5 to 700, percentages by weight being expressed as relative to the total monomer weight.

Other useful graft silicone polymers according to the present disclosure include polydimethyl siloxanes (PDMS) onto which mixed polymer units of the poly(meth)acrylic acid and alkyl poly(meth)acrylate type are graft through a thiopropylene type chain member, and polydimethyl siloxanes (PDMS) onto which polymer units of the isobutyl poly(meth)acrylate type are graft through a thiopropylene type chain member.

Functionalized or not, silicone or non silicone polyurethanes may also be used as fixing polymers.

Suitable polyurethanes according to the present disclosure include but are not limited to those described in European Patent Application Nos. EP 0 751 162, EP 0 637 600, EP 0 648 485, EP 0 619 111 and EP 0 656 021, and in French Application No. FR 2 743 297, as well as in International Patent Application No. WO 94/03510.

By way of non-limiting example, the non silicone fixing polyurethane may be the LUVISET PUR polymer available from the BASF company, and the silicone fixing polyurethane may be the LUVISET Si PUR polymer also available from the BASF company.

According to at least one embodiment of the present disclosure, the at least one fixing polymer is chosen from silicone or non silicone polyurethanes, linear sulfonic polyesters, branched acrylic block copolymers, and copolymers of octyl acrylamide, acrylates and butylaminoethyl methacrylates.

Non-limiting examples of fixing polymers include AMPHOMER from NATIONAL STARCH, LUVISET Si Pur from BASF, FIXATE G100 from NOVEON, MEXOMERE PW from CHIMEX, and AQ 55S from EASTMAN.

In at least one embodiment, the at least one fixing polymer is present in an amount ranging from 0.1 to 20% by weight relative to the total weight of the cosmetic composition, for example from 1 to 12% by weight.

According to at least one embodiment, the cosmetic composition may further comprise cosmetically acceptable active agents, such as surfactants, thickeners, penetrating agents, fragrances, peptizing agents, buffers, and various traditional additives such as sunscreen agents, waxes, volatile or non volatile, cyclic or linear or branched, organomodified silicones optionally with amine groups, preserving agents, ceramides, pseudoceramides, mineral, vegetable or synthetic oils, vitamins or provitamins, such as panthenol, opacifying agents, reducing agents, emulsifying agents, fillers, proteins, moisturizing agents, emollients, softening agents, anti-foam agents, anti-free radical agents; bactericides, sequestering agents, anti-dandruff agents, antioxidants, alkalinizing agents, polyols, anti-corrosive agents and any other additive traditionally used in cosmetic compositions intended to be applied onto the hair.

In at least one embodiment, the additional additives are silicones.

Suitable silicones used as additives in the cosmetic compositions according to the present disclosure are volatile or non volatile, cyclic, linear or branched silicones, optionally modified with organic groups, and having a viscosity ranging from 5.10⁻⁶ to 2.5 m²/s at 25° C., for example from 1.10⁻⁵ to 1 m²/s.

Silicones to be used according to the present disclosure may be present in a form which is soluble in, or micro- or nanodispersed within, the composition, and, in one embodiment, may be polyorganosiloxanes insoluble in the composition of the disclosure. They may be present, for example, in the form of oils, waxes, resins or gums.

Organopolysiloxanes are defined, for example in “Chemistry and Technology of Silicones” by Walter NOLL (1968) Academie Press. They may be volatile or not.

Accordingly, when they are volatile, the silicones are have a boiling point ranging from 60° C. to 260° C., and are chosen from:

(i) cyclic polydialkyl siloxanes comprising from 3 to 7 silicone atoms, for example 4 or 5 silicon atoms. Suitable examples include, but are not limited to octamethyl cyclotetrasiloxane marketed, for instance, under the trade name “VOLATILE SILICONE® 7207” by UNION CARBIDE or “SILBIONE® 70045 V 2” by RHODIA, decamethyl cyclopentasiloxane marketed, for example, under the trade name “VOLATILE SILICONE® 7158” by UNION CARBIDE, “SILBIONE® 70045 V 5” by RHODIA, and mixtures thereof.

Non-limiting mention may also be made of cyclocopolymers of the dimethyl siloxane and methylalkyl siloxane type, such as “SILICONE VOLATILE® FZ 3109” marketed by the UNION CARBIDE company, having the following formula:

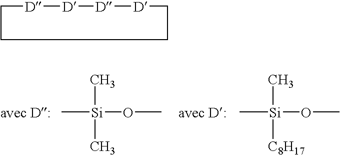

wherein avec=with

Mixtures of cyclic polydialkyl siloxanes with organic compounds derived from silicon that may also be mentioned, include, but are not limited to the octamethyl cyclotetrasiloxane and tetratrimethylsilyl pentaerythritol mixture (50:50) and the octamethyl cyclotetrasiloxane and oxy-1,1′-(hexa-2,2,2′,2′,3,3′-trimethylsilyloxy) bis-neopentane mixture;

(ii) linear volatile polydialkyl siloxanes comprising from 2 to 9 silicon atoms with a viscosity lower than or equal to 5.10⁻⁶ m²/s at 25° C., for example decamethyl tetrasiloxane marketed, for instance under the trade name “SH 200” by the TORAY SILICONE company. Silicones belonging to this class are also described in the article published in Cosmetics and Toiletries, Vol. 91, Jan. 76, P. 27-32—TODD & BYERS “Volatile Silicone fluids for cosmetics”.

According to at least one embodiment of the present disclosure, non volatile polydialkyl siloxanes are used, as well as polydialkyl siloxane gums and resins, polyorganosiloxanes modified with the previously mentioned organofunctional groups, and mixtures thereof.

These silicones are, for example chosen from polydialkyl siloxanes, such as polydimethyl siloxanes with trimethylsilyl end groups. According to the present disclosure, silicone viscosity is measured at 25° C. according to ASTM 445 standard, Appendix C.

These polydialkyl siloxanes encompass, by way of non-limiting example, the following commercial products:
SILBIONE® oils of 47 and 70 047 series or MIRASIL® oils marketed, for instance by RHODIA, such as the oil 70 047 V 500 000;
oils of MIRASIL® series marketed, for example by the RHODIA company;
oils of 200 series from the DOW CORNING company, such as DC200 (viscosity 60 000 mm²/s); and
VISCASIL® oils from GENERAL ELECTRIC and some oils of SF (SF 96, SF 18) series from GENERAL ELECTRIC.

Other useful polydialkyl siloxanes include, but are not limited to dimethylsilanol end group-containing polydimethyl siloxanes, known under the name dimethiconol in the CTFA dictionary, such as oils of the 48 series from the RHODIA company.

This polydialkyl siloxane class also includes (C₁-C₂₀) polydialkyl siloxanes marketed, for example under the trade names “ABIL WAX® 9800 and 9801” by the GOLDSCHMIDT company.

Suitable silicone gums according to the present disclosure include but are not limited to polydialkyl siloxanes, for example polydimethyl siloxanes having a high number average molecular weight ranging from 200 000 to 1 000 000 used either alone or in combination in a solvent. By way of non-limiting example, this solvent may be chosen from volatile silicones, polydimethyl siloxane (PDMS) oils, polyphenylmethyl siloxane (PPMS) oils, isoparaffins, polyisobutylenes, methylene chloride, pentane, dodecane, tridecane and mixtures thereof.

The following mixtures are products which may be suitably used according to at least one embodiment of the present disclosure:

mixtures formed from an end chain-hydroxylated polydimethyl siloxane (also called dimethiconol, CTFA) and a cyclic polydimethyl siloxane, also called cyclomethicone (CTFA), such as the Q2 1401 product marketed by the DOW CORNING company;

mixtures formed from a polydimethyl siloxane gum and a cyclic silicone, such as the SF 1214 Silicone Fluid from the GENERAL ELECTRIC company, this product being a SF 30 gum corresponding to a dimethicone, having a number average molecular weight of 500 000, solubilized in the SF 1202 Silicone Fluid corresponding to decamethyl cyclopentasiloxane; and

mixtures from two PDMS with different viscosities, for example from a PDMS gum and a PDMS oil, such as the SF 1236 product from GENERAL ELECTRIC. SF 1236 is a mixture from a SE 30 gum as defined above with a viscosity of 20 m²/s and a SF 96 oil with a viscosity of 5.10⁶ m²/s. Such product comprises for example 15% of SE 30 gum and 85% of SF 96 oil.

Other useful organopolysiloxane resins according to the present disclosure include but are not limited to crosslinked siloxane systems comprising R₂SiO_{2/2}, R₃SiO_{1/2}, RSiO_{3/2} and SiO_{4/2} units, wherein R is an alkyl group comprising from 1 to 16 carbon atom(s). In at least one embodiment, R is a lower C₁-C₄ alkyl group, for example a methyl group.

These resins also include dimethyl/trimethyl siloxane-structured silicones marketed, for example under the trade name “DOW CORNING 593” or those marketed, for instance under the trade names “SILICONE FLUID SS 4230 and SS 4267” by the GENERAL ELECTRIC company.

Resins of the trimethyl siloxysilicate type marketed, for instance under the trade names X22-4914, X21-5034 and X21-5037 by the SHIN-ETSU company may also be mentioned by way of non-limiting example.

Other useful organomodified silicones include but are not limited to those comprising in their structure one or more organofunctional group(s) bound through a hydrocarbon group.

In addition to the silicones defined above, other suitable organomodified silicones include, by way of non-limiting example: polydiaryl siloxanes, for instance polydiphenyl siloxanes, and polyalkylaryl siloxanes functionalized with the organofunctional groups as previously mentioned.

Polyalkylaryl siloxanes are chosen, for example from linear and/or branched, polydimethyl methylphenyl siloxanes and polydimethyl diphenyl siloxanes, with a viscosity ranging from 1.10⁻⁵ to 5.10⁻² m²/s at 25° C.

Suitable examples of such polyalkylaryl siloxanes include, but are not limited to the products marketed under the following trade names:

SILBIONE® oils of 70 641 series from RHODIA;

oils of RHODORSIL® 70 633 and 763 series from RHODIA;

DOW CORNING 556 COSMETIC GRAD FLUID oil from DOW CORNING;

silicones of PK series from BAYER, such as the PK20 product;

silicones of PN, PH series from BAYER, such as PN1000 and PH1000 products; and

some oils of SF series from GENERAL ELECTRIC, such as SF 1023, SF 1154, SF 1250, SF 1265.

Other suitable organomodified silicones include polyorganosiloxanes comprising:

polyethyleneoxy and/or polypropyleneoxy groups optionally comprising C₆-C₂₄ alkyl groups, such as products called dimethicone copolyol marketed by the DOW CORNING company under the trade name DC 1248 or SILWET® L 722, L 7500, L 77, L 711 oils from the UNION CARBIDE company and (C₁₋₂)alkyl methicone copolyol marketed by the DOW CORNING company under the trade name Q2 5200;

optionally substituted amine groups, such as the products marketed under the trade name GP 4 Silicone Fluid and GP 7100 by the GENESEE company, or the products marketed under the trade names Q2 8220 and DOW CORNING 929 or 939 by the DOW CORNING company. Substituted amine groups include, by way of non-limiting example C₁-C₄ aminoalkyl groups.

alkoxyl groups, such as the product marketed under the trade name “SILICONE COPOLYMER F-755” by SWS SILICONES and ABIL WAX® 2428, 2434 and 2440 by the GOLDSCHMIDT company.

According to at least one embodiment, the silicones may be chosen from volatile, linear or cyclic polydimethyl siloxanes and phenyl silicones.

In another embodiment, silicones as defined above, may be used either alone or in combination, and may be present in an amount ranging from 0.01 to 20% by weight, for example from 0.1 to 5% by weight.

According to at least one embodiment of the present disclosure, the additives include hair fiber protecting agents.

Useful hair fiber protecting agents may be any active agent efficient for preventing or limiting any hair damage resulting from physical or chemical stress.

Thus, the hair fiber protecting agent may be chosen from, by way of non-limiting example, organic water-soluble, fat-soluble UV radiation-filtering systems, anti-free radical agents, antioxidants, vitamins, provitamins, vegetable waxes, ceramides, proteins and mixtures thereof.

According to the present disclosure, organic UV radiation-filtering systems are chosen from, for example, water-soluble or fat-soluble, silicone or non silicone filters and mineral oxide nanoparticles, the surface of which has optionally been treated so as to become hydrophilic or hydrophobic.

Organic water-soluble UV radiation-filtering systems may be, by way of not-limiting example, chosen from para-aminobenzoic acid and salts thereof, anthranilic acid and salts thereof, salicylic acid and salts thereof, p-hydroxycinnamic acid and salts thereof, benz-x-azole sulfonic derivatives (benzothioazoles, benzimidazoles, benzoxazoles) and their salts, benzophenone sulfonic derivatives and their salts, benzylidene camphor sulfonic derivatives and their salts, benzylidene camphor derivatives substituted with a quaternary amine and their salts, phthalydene-camphosulfonic acid derivatives and their salts, and benzotriazole sulfonic derivatives.

Hydrophilic polymers may also be used, which have UV radiation-photoprotecting properties, for example polymers comprising benzylidene camphor and/or benzotriazole groups, substituted with sulfonic or quaternary ammonium groups.

Useful organic fat-soluble (or lipophilic) UV radiation-filtering systems that can be suitably used according to the present disclosure, include but are not limited to p-aminobenzoic acid derivatives, such as p-aminobenzoic acid esters or amides; salicylic acid derivatives such as esters; benzophenone derivatives; dibenzoylmethane derivatives; diphenyl acrylate derivatives; benzofurane derivatives; polymer-based UV radiation-filtering systems comprising one or more silico-organic residue(s); cinnamic acid esters; camphor derivatives; trianilino-s-triazine derivatives; urocanic acid ethyl ester; benzotriazoles; hydroxyphenyl triazine derivatives; bis-resorcinol dialkylaminotriazines; and mixtures thereof.

Non-limiting examples of fat-soluble (or lipophilic) UV filters include, but are not limited to octyl salicylate; 4-tertbutyl 4′-methoxydibenzoylmethane (PARSOL 1789 from GIVAUDAN); octocrylene; 2-ethylhexyl 4-methoxy cinnamate (PARSOL MCX) and the compound of following formula (XIII), or 2-(2H-benzotriazole-2-yl)-4-methyl-6-[2-methyl-3-[1,3,3,3-tetramethyl-1-[(trimethylsilyl)oxy]disiloxanyl]propynyl]phenol, described, for instance in European Patent Application No. EP-A-0 392 883:

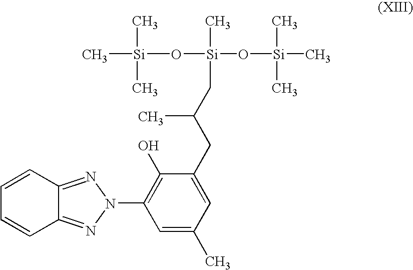

Other useful UV radiation-filtering systems according to the present disclosure include, but are not limited to benzophenone derivatives such as UVINUL MS 40 (2-hydroxy 4-methoxybenzophenone-5-sulfonic acid) and UVINUL M40 (2-hydroxy-4-methoxybenzophenone) marketed by BASF, benzalmalonate derivatives such as PARSOL SLX (polydimethyl/methyl (3(4-(2,2-bis-ethbxycarbonylvinyl)-phenoxy)-propenyl)siloxane) marketed by GIVAUDAN-ROURE, benzylidene-camphor derivatives such as MEXORYL SX (b-b′camphosulfonic acid [1-4 divinyl benzene]) made by the CHIMEX company, and benzimidazole derivatives such as EUSOLEX 232 (2-phenyl-benzimidazol-5-sulfonic acid) marketed by MERCK.

The pH value may be adjusted to the expected level by using acidifying or alkalinizing agents that are well known from the state of the art.

Suitable alkalinizing agents include, for example ammonia, alkaline carbonates, alkanolamines such as mono-, di- and triethanolamines as well as their derivatives, oxyethylenated and/or oxypropylenated hydroxyalkyl amines and ethylene diamines, sodium or potassium hydroxides and compounds of following formula:

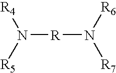

wherein R is a propylene residue optionally substituted by a hydroxyl group or a C₁-C₄ alkyl radica; and R₄, R₅, R₆ and R₇, which are identical or different, are independently chosen from a hydrogen atom, a C₁-C₄ alkyl radical and a C₁-C₄ hydroxyalkyl radical. In at least one embodiment of the present disclosure, the alkalinizing agent is triethanol amine.

Suitable acidifying agents include, but are not limited to mineral or organic acids such as hydrochloric acid, and orthophosphoric acid, and carboxylic acids such as tartaric acid, citric acid, lactic acid and sulfonic acids.

According to at least one embodiment of the present disclosure, the compositions may further comprise direct dyes.

Suitable examples of direct dyes include, but are not limited to neutral, acidic or cationic nitrobenzene direct dyes, neutral, acidic or cationic azo direct dyes, quinone direct dyes, for example neutral, acidic or cationic anthraquinone direct dyes, azine direct dyes, triarylmethane direct dyes, indoamine direct dyes and natural direct dyes.

Amongst the preserving agents, sorbic acid and salts thereof, parahydroxybenzoic acid esters and phenoxyethanol may be mentioned, by way of non-limiting example.

Suitable examples of anticorrosive agents include, but are not limited to cyclohexyl amine, diammonium phosphate, dilithium oxalate, dimethylamino methylpropanol, dipotassium oxalate, dipotassium phosphate, disodium phosphate, disodium pyrophosphate, disodium tetrapropenyl succinate, hexoxyethyl diethylammonium phosphate, nitromethane, potassium silicate, sodium aluminate, sodium hexametaphosphate, sodium metasilicate, sodium molybdate, sodium nitrite, sodium oxalate, sodium silicate, stearamidopropyl dimethicone, tetrapotassium pyrophosphate and triisopropanolamine.

According to at least one embodiment of the present disclosure, the cosmetic composition may further comprise a compound chosen from alkalinizing agents, acidifying agents, silicones, organic solvents, fragrances, preserving agents, UV radiation-absorbing agents, coloring agents, anticorrosive agents, and mixtures thereof.

The cosmetic composition according to the present disclosure may further comprise water.

The cosmetically acceptable medium of the composition according to the present disclosure may further comprise at least one organic solvent.

As disclosed herein, “organic solvent” is understood to mean an organic compound which is in the liquid state at a temperature of 25° C. and at the atmospheric pressure (760 mm mercury (Hg)).

The organic solvent(s) useful in the cosmetic composition herein may be chosen from, for example, C₁-C₆ alcohols, alkanols such as ethanol, propanol and isopropanol, polyols such as glycerol, propylene glycol and pentanediol, benzyl alcohol, and mixtures thereof.

In at least one embodiment, the organic solvent is ethanol.

When present, said organic solvent is present in an amount ranging from 1 to 98% relative to the total weight of the composition, for example from 20 to 95%.

According to at least one embodiment of the present disclosure, the spraying device comprising a composition as disclosed herein may be used for non rinsed-off applications, either on dry hair or on wet hair.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in its respective testing measurement.

The examples that follow are intended to illustrate the present disclosure without being limiting in nature.

### EXAMPLES OF FORMULATION

### Example 1

### Composition 1

| | |
|---|---|
| Terpolymer of vinyl acetate/vinyl p-tertbutyl benzoate/crotonic | 6.00 g |
| acid (65:25:10) as expressed by weight of the polymer | |
| 2-amino-2-methyl-1-propanol | 0.60 g |
| Ethylhexyl methoxycinnamate marketed by ROCHE VITAMINS | 0.05 g |
| under the trade name PARSOL MCX | |
| Fragrance | 0.10 g |
| Ethyl alcohol, absolute qs | 100 g |

The composition 1 was conditioned in a spraying device as defined herein. This device comprised a membrane with perforations having a cross-sectional area in the form of a circular plate with a diameter ranging from 4 to 150 μm on the outer surface of the membrane facing the external environment, and on the inner surface facing the inside of the container, a cross-sectional area in the form of a circular plate with a diameter ranging from 2 to 50 μm. This device comprised a piezoelectric actuator able to vibrate the membrane as well as an electric cell that supplied the piezoelectric actuator with the necessary energy. The perforations in the device had a reverse taper.

When using the device, the cosmetic composition was dispensed as droplets with a mean diameter ranging from 20 to 100 μm.

### Example 2

### Composition 2

| | |
|---|---|
| Terpolymer of vinyl acetate/vinyl p-tertbutyl benzoate/crotonic | 6.00 g |
| acid (65:25:10) as expressed by weight of the polymer | |
| 2-amino-2-methyl-1-propanol | 0.60 g |
| Ethylhexyl methoxycinnamate marketed by ROCHE VITAMINS | 0.05 g |
| under the trade name PARSOL MCX | |
| Demineralized water | 14 g |
| Fragrance | 0.1 g |
| Ethyl alcohol, absolute qs | 100 g |

The composition 2 defined above was conditioned in a spraying device similar to that described in example 1.

### Example 3

### Composition 3

| | |
|---|---|
| LUVISET SI-PUR A resin marketed by BASF (polyurethane-6) | 9.00 |
| as expressed by weight of the polymer | |
| Ethylhexyl methoxycinnamate marketed by ROCHE VITAMINS | 0.05 |
| under the trade name PARSOL MCX | |
| Demineralized water (contained in the polymer in its commercial | 18 |
| form) | |
| Demineralized water | 18 |
| Fragrance | 0.10 |
| Ethyl alcohol, absolute qs | 100 |

The composition 3 defined above was conditioned in a spraying device similar to that described in example 1.

The spraying device described in example 1 and containing the composition 1, 2 or 3, such as defined above made it possible to obtain a good hair hold quality and/or an easy removability from the hair by brushing, which usually could not be obtained with the known devices without propellants such as pump-type dispenser bottles.

The application may equally be carried out on wet hair or on dry hair.

What is claimed is:

1. A spraying device for a cosmetic composition comprising a container having inner space comprising a liquid cosmetic composition and provided with a spraying mechanism comprising:
a perforated membrane, wherein the membrane perforations allow the inner space of the container to communicate with the external environment,
an actuator for vibrating the membrane, and
a mechanism for making the liquid cosmetic composition contained in the container contact an inner surface of the membrane,
where the liquid cosmetic composition, under the effect of the membrane vibrations, flows through the perforations until reaching an outer surface of the membrane, from which it emerges as droplets, and
said liquid cosmetic composition comprising, in a cosmetically acceptable medium, at least one fixing polymer.

2. A spraying device according to claim 1, wherein the perforated membrane comprises perforations having a reverse taper.

3. A spraying device according to claim 1, wherein the device further comprises a pressure bias mechanism providing a reduced pressure to the liquid contacting the inner surface of the membrane.

4. A spraying device according to claim 3, wherein the reduced pressure varies from ambient pressure up to the pressure at which air is sucked-in through the perforations of the membrane contacting the composition.

5. A spraying device according to claim 1, wherein the perforations arranged on the outer surface of the membrane do not contact each other.

6. A spraying device according to any claim 1, wherein the actuator is a piezoelectric actuator.

7. A spraying device according to claim 1, wherein the mechanism for conveying the liquid cosmetic composition to the surface of the membrane comprises a capillary-based feeding mechanism.

8. A spraying device according to claim 1, wherein the mechanism for conveying the liquid cosmetic composition to the surface of the membrane comprises a bubble generator-based feeding mechanism.

9. A spraying device according to claim 1, wherein all the perforations have a reverse taper.

10. A spraying device according to claim 1, wherein the membrane further comprises normally tapered perforations.

11. A spraying device according to claim 10, wherein the normally tapered perforations are arranged all around and on the outside of the perforations with reverse tapers.

12. A spraying device according to claim 1, wherein the actuator is designed to make said membrane vibrate within a frequency range of from 20 KHz to 7 MHz.

13. A spraying device according to claim 1, wherein the at least one fixing polymer is chosen from anionic, cationic, amphoteric and non ionic fixing polymers.

14. A spraying device according to claim 1, wherein the at least one fixing polymer is chosen from copolymers derived from crotonic acid comprising in their chain vinyl acetate or propionate units and optionally other monomers chosen from allyl, methallyl or vinyl esters of a linear or branched, hydrocarbon long-chain, saturated carboxylic acid comprising at least 5 carbon atoms, where these polymers may be optionally graft and crosslinked, and vinyl, allyl or methallyl esters of a α- or β-cyclic carboxylic acid.

15. A spraying device according to claim 1, wherein the at least one fixing polymer is a terpolymer of vinyl acetate, vinyl p-tertbutyl benzoate and crotonic acid.

16. A spraying device according to claim 1, wherein the at least one fixing polymer is chosen from silicone or non silicone polyurethanes, linear sulfonic polyesters, branched acrylic block copolymers, and copolymers of octyl acrylamide, acrylates and butylaminoethyl methacrylates.

17. A spraying device according to claim 1, wherein the at least one fixing polymer is present in an amount ranging from 0.1 to 20% by weight, relative to the total weight of the cosmetic composition.

18. A spraying device according to claim 17, wherein the at least one fixing polymer is present in an amount ranging from 1 to 12% by weight, relative to the total weight of the cosmetic composition

19. A spraying device according to claim 1, wherein the cosmetic composition comprises water.

20. A spraying device according to claim 1, wherein the cosmetic composition comprises at least one additive chosen from alkalinizing agents, acidifying agents, silicones, fragrances, preserving agents, UV radiation-absorbing agents, colouring agents, anticorrosive agents and mixtures thereof.

21. A spraying device according to claim 1, wherein the cosmetically acceptable medium comprises at least one organic solvent chosen from C₁-C₆ alcohols, from polyols, benzyl alcohol, and mixtures thereof.

22. A spraying device according to claim 19, wherein the at least one organic solvent is ethanol.
